(19) United States
(12) Patent Application Publication
(10) Pub. No.: US 2023/0371767 A1
(43) Pub. Date: Nov. 23, 2023

(54) PET BRUSH

(71) Applicant: LINCOS CO., LTD., TOSHIMA-KU, TOKYO (JP)

(72) Inventor: Shihui XU, FENGTAI DISTRICT, BEIJING (CN)

(21) Appl. No.: 18/030,343

(22) PCT Filed: Jun. 8, 2021
(86) PCT No.: PCT/JP2021/021796

§ 371 Date: Apr. 5, 2023

(51) Int. Cl. A47L 9/06

(52) U.S. Cl. CPC A47L 9/0613; A47L 9/0673; A47L 9/0653

(57) ABSTRACT

Provided is a pet brush capable of efficiently performing brushing and cleaning of fallen hair or the like scattered the surroundings or adhering to furniture without taking time and effort. A pet brush includes a head main body that is formed into a hollow shape and in which a connection port, which is connectable to a suction hose connected to a vacuum cleaner, and a suction port for suction are open, an elastic cleaning portion that is provided in the head main body and is made of an elastic body, and a brush member that is provided in the head main body. The brush member is supported by the head main body to be movable between a use position at which the brush member protrudes from the head main body and a storage position at which the brush member is stored inside the head main body.

### TECHNICAL FIELD

The present disclosure relates to a pet brush.

### BACKGROUND ART

In the related art, as a pet brush, a pet brush that is connected to a vacuum cleaner and capable of performing brushing while performing suction is known (see, for example, Patent Literature 1 and Patent Literature 2).

The pet brush disclosed in Patent Literature 1 has a structure in which a bowl-shaped anti-scattering cover is provided at a distal end of a nozzle that is connectable to a vacuum cleaner, and a brush is attached to an inside of the anti-scattering cover. Therefore, by performing the brushing while performing the suction by the vacuum cleaner, it is possible to suck fallen hair or dust removed by the brush by the vacuum cleaner and to suppress scattering to the surroundings.

Similar to the pet brush disclosed in Patent Literature 1, with the pet brush disclosed in Patent Literature 2, it is possible to perform the brushing while performing the suction by a vacuum cleaner. Further, in the pet brush disclosed in Patent Literature 2, a plurality of comb teeth are provided on a roller, and in a case in which a certain amount of fallen hair adheres to the comb teeth, it is possible to perform the brushing with new comb teeth by rotating roller.

### Citation List

### Patent Literatures

Patent Literature 1: Japanese Patent Application Laid-Open No. 2011-130752
Patent Literature 2: Japanese Patent Application Laid-Open No. 2013-244399

### SUMMARY OF INVENTION

### Technical Problem

However, in the related art, although it is possible to suppress scattering of fallen hair, sebum, or the like in a case in which the brushing of hair of a pet is performed, it is difficult to completely eliminate scattering. In addition, the fallen hair, the sebum, or the like is caused at a time other than a time of the brushing, and adheres to furniture, such as a sofa, or clothing of an owner. Such fallen hair or sebum may cause an allergic symptom, and thus it is desirable to reliably remove the fallen hair, the sebum, or the like.

Therefore, in a case in which the cleaning of the fallen hair or the like adhering to the furniture or the clothing is performed, a head connected to a hose of the vacuum cleaner is replaced with a cleaning head. Therefore, it takes time and effort to replace the head between the brushing and the cleaning, and it is difficult to sufficiently remove the fallen hair, the sebum, or the like by using only the suction force of the vacuum cleaner.

The present disclosure has focused on the above-described problems in the related art, and is to provide a pet brush capable of efficiently and effectively performing the brushing and the cleaning of the scattered fallen hair or the like without taking time and effort.

### Solution to Problem

In order to achieve the above object, the present disclosure relates to a pet brush including a main body that is formed into a hollow shape and in which a connection port, which is connectable to a hose connected to a vacuum cleaner, and a suction port for suction are open, an elastic cleaning portion that is provided in the main body and is made of an elastic body, and a brush member that is provided in the main body. The brush member is supported by the main body to be movable between a use position at which the brush member protrudes from the main body and a storage position at which the brush member is stored inside the main body.

The pet brush according to the present disclosure is possible to efficiently and effectively use the pet brush of the present disclosure in two ways of use as a brush and use of cleaning to remove the fallen hair, the sebum, the dust, or the like, without replacing the cleaning head. That is, it is possible to brush a pet at the use position at which the brush member protrudes from the main body. In this case, by performing the suction operation of the vacuum cleaner in a state in which the hose is connected to the connection port, it is possible to suck the fallen hair or the dust due to the brushing by the vacuum cleaner, and to suppress the scattering of the fallen hair, the sebum, or the like to the surroundings.

On the other hand, in a case in which the brush member is moved to the storage position and stored inside the main body, it is possible to use the elastic cleaning portion to adsorb and remove the fallen hair adhering to the pet, or the fallen hair, the sebum, or the like adhering to the furniture or the like by the elastic cleaning portion without the brush member becoming an obstacle. In this case, by performing the suction operation of the vacuum cleaner in a state in which the hose is connected to the connection port, it is possible to suck the fallen hair or the dust adsorbed to the elastic cleaning portion by the vacuum cleaner. As described above, since it is possible to suck the fallen hair or the like by the vacuum cleaner while removing by the fallen hair or the like by the elastic cleaning portion made of the elastic body, it is possible to obtain higher removal performance as compared with a case in which the cleaning is performed by using only the suction force of the vacuum cleaner.

### BRIEF DESCRIPTION OF DRAWINGS

FIG. 1 is a perspective view of a pet brush according to a first embodiment as viewed from diagonally above.

FIG. 2 is a perspective view of the pet brush according to the first embodiment as viewed from diagonally below.

FIG. 3A is a vertical cross-sectional view illustrating attachment and detachment of the pet brush according to the first embodiment.

FIG. 3B is a vertical cross-sectional view illustrating attachment and detachment of the pet brush according to the first embodiment.

FIG. 4 is a bottom view of the pet brush according to the first embodiment.

FIG. 5 is a rear view of the pet brush according to the first embodiment.

FIG. 6A is a perspective view illustrating a state in which a brush member is disposed at a use position with respect to a brush support member in a first replacement brush of the pet brush according to the first embodiment.

FIG. 6B is a perspective view illustrating a state in which the brush member is disposed at a storage position with respect to the brush support member in the first replacement brush of the pet brush according to the first embodiment.

FIG. 7A is a perspective view illustrating a state in which the brush member is disposed at the use position with respect to the brush support member in a second replacement brush of the pet brush according to the first embodiment.

FIG. 7B is a perspective view illustrating a state in which the brush member is disposed at the storage position with respect to the brush support member in the second replacement brush of the pet brush according to the first embodiment.

FIG. 8 is a perspective view illustrating a state in which the brush member is disposed at the use position with respect to the brush support member in a third replacement brush of the pet brush according to the first embodiment.

FIG. 9A is a cross-sectional view illustrating a state in which the brush member of the first replacement brush in the pet brush according to the first embodiment is disposed at the use position with respect to the brush support member and a head main body.

FIG. 9B is a cross-sectional view illustrating a state in which the brush member of the first replacement brush in the pet brush according to the first embodiment is disposed at the storage position with respect to the brush support member and the head main body.

FIG. 10 is a perspective view illustrating a state in which a circuit board and a battery are detached from the head main body in the pet brush according to the first embodiment.

FIG. 11 is a circuit block diagram illustrating a control circuit in the pet brush according to the first embodiment.

### DESCRIPTION OF EMBODIMENTS

Hereinafter, embodiments for realizing a pet brush according to the present disclosure will be described with reference to the drawings.

(Description of Overall Structure of Pet Brush)

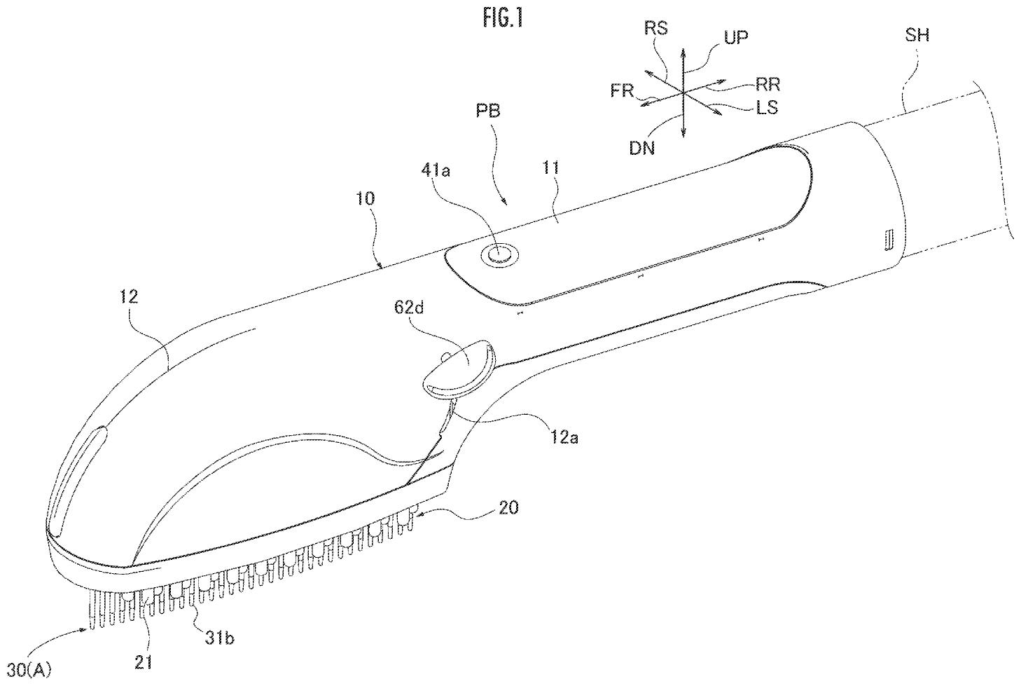

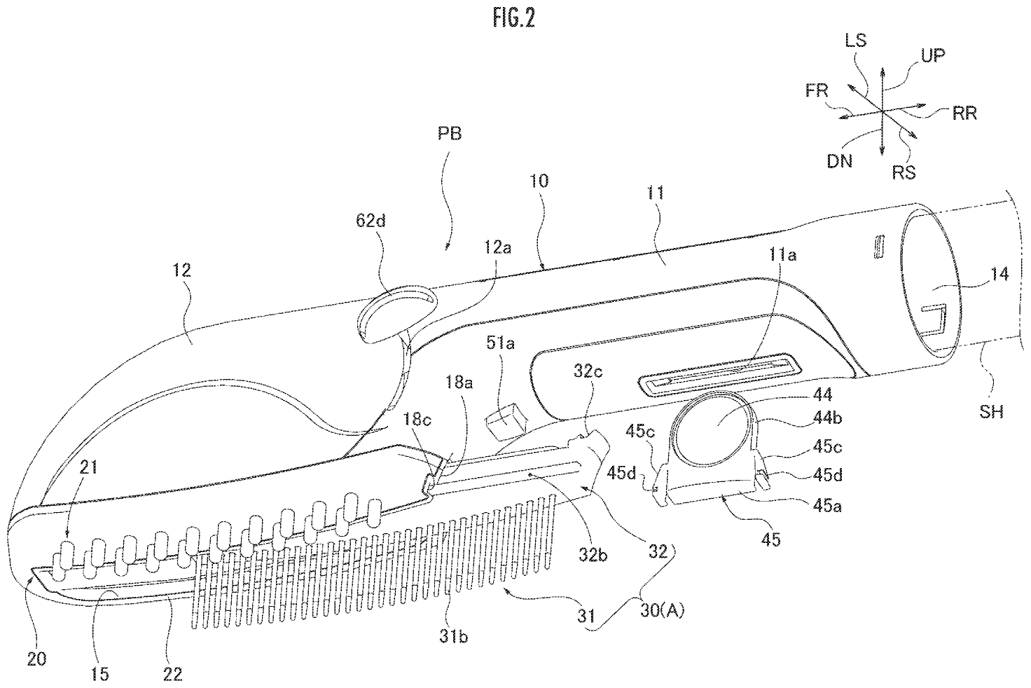

FIG. 1 is a perspective view of a pet brush PB according to a first embodiment as viewed from diagonally above, and FIG. 2 is a perspective view of the pet brush PB according to the first embodiment as viewed from diagonally below. In FIGS. 1 and 2, a direction of an arrow UP is an upward direction, a direction of an arrow DN is a downward direction, a direction of an arrow FR is a forward direction, a direction of an arrow RR is a rearward direction, a direction of an arrow LS is a left direction, and a direction of an arrow RS is a right direction. These directions are based on the directions as viewed by a user when the pet brush PB is used and gripped by the user.

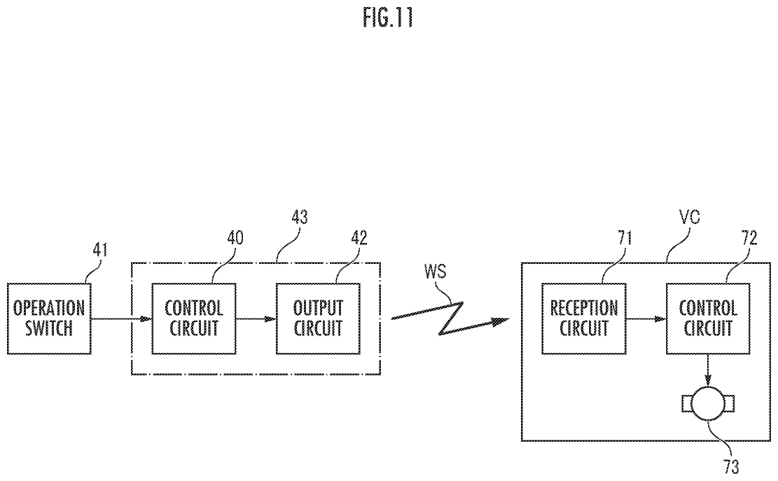

The pet brush PB according to the first embodiment is formed as a vacuum cleaner head used by being connected to a suction hose SH connected to a vacuum cleaner VC (see FIG. 11), and includes a head main body 10 illustrated in FIGS. 1 and 2, an elastic cleaning portion 20, a replacement brush 30, and a control circuit 40 (see FIG. 11). In the first embodiment, a suction hose having a length of 3 m to 5 m, which is longer than a normal cleaning hose, is used as the suction hose SH. In addition, in this case, a suction hose having elasticity may be used as the suction hose SH, and the suction hose may have a length of 3 m to 5 m when being extended.

(Description of Head Main Body)

First, the head main body 10 will be described.

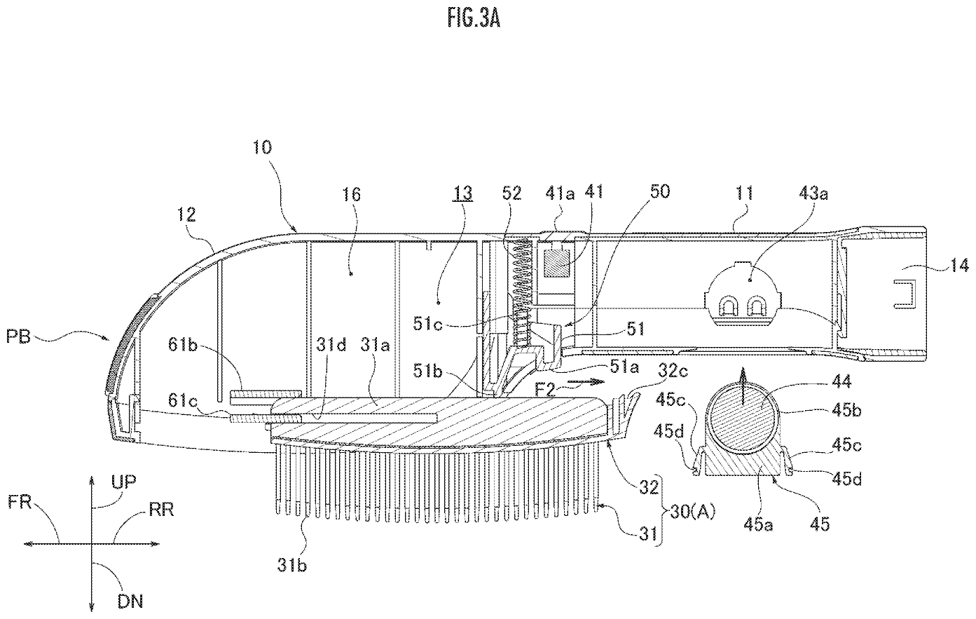

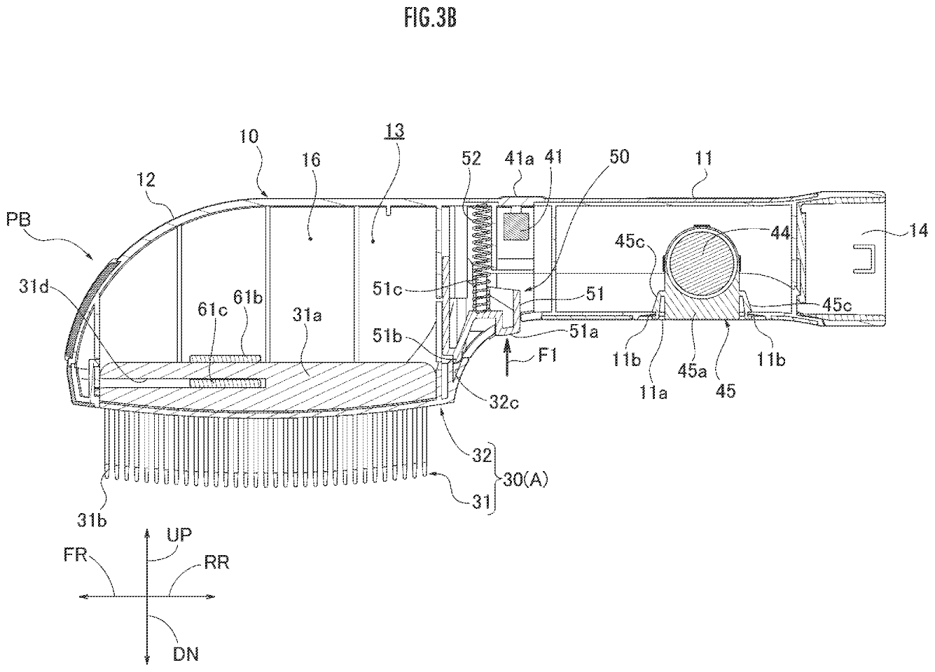

The head main body 10 includes a grip portion 11 and a suction portion 12. As illustrated in FIGS. 3A and 3B, the head main body 10 is formed into a hollow shape having a hollow portion 13 inside.

The grip portion 11 is a portion to be gripped by the user during use of the brushing and the cleaning, is formed into a circular tube shape, and has a rear end in which a connection port 14 for connecting the suction hose SH connected to the vacuum cleaner VC is open.

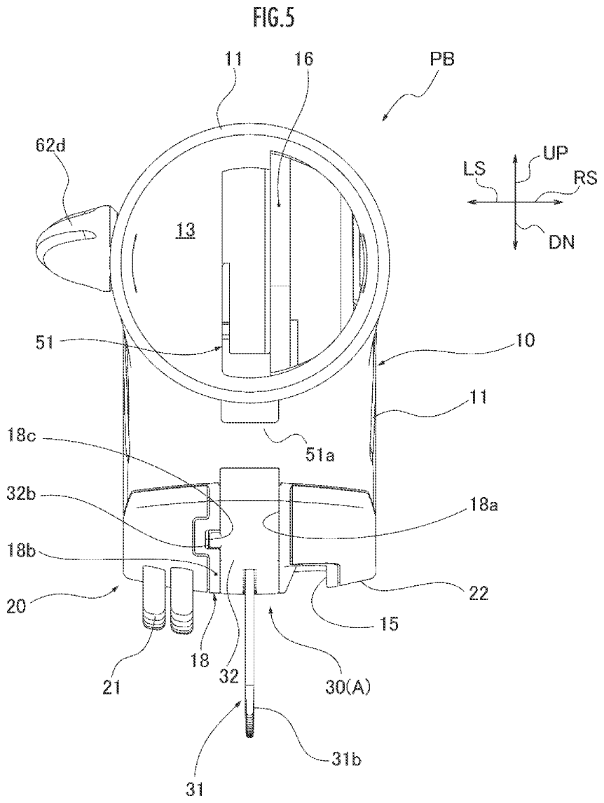

The suction portion 12 is a portion that performs the brushing and the suction by being brought close to or in contact with a pet, and extends forward from the grip portion 11 and bulges out downward. A lower surface of the suction portion 12 has a shape that is gently curved in the front-rear direction and the left-right direction. That is, as illustrated in FIGS. 3A, 3B and 5, a central portion bulges out most downward in the front-rear direction and the left-right direction, and front-rear end portions and the left-right end portions are curved to be positioned above the central portion.

In addition, a suction port 15, which is long in the front-rear direction, and a brush support frame portion 18 are provided in parallel in a central portion of a lower surface of the suction portion 12 in the left-right direction.

The suction port 15 is a portion in which the suction hose SH is connected to the connection port 14 to perform the suction in a case in which a suction operation of the vacuum cleaner VC is performed, and the matters sucked from the suction port 15 are sucked by the vacuum cleaner VC by passing from the suction port 15 through the hollow portion 13 and then passing from the connection port 14 through the suction hose SH.

The brush support frame portion 18 is provided adjacent to the suction port 15 and supports a brush support member 32 of the replacement brush 30, which will be described below, to be slidable. The brush support frame portion 18 has an attachment/detachment opening 18a through which the brush support portion 32 is capable of being taken in and out at a rear end portion, and is formed into a shape surrounded by a side wall 18b which has a U-shape long in the front-rear direction. In addition, a recess-shaped engagement slide groove 18c extends in the front-rear direction on the side wall 18b.

As illustrated in FIG. 5, the hollow portion 13 of the head main body 10 is provided with an intermediate wall 16 erected at the middle in the left-right direction. In addition, the intermediate wall 16 is provided over substantially the entire length of the hollow portion 13 of the head main body 10 in the front-rear direction.

(Description of Elastic Cleaning Portion)

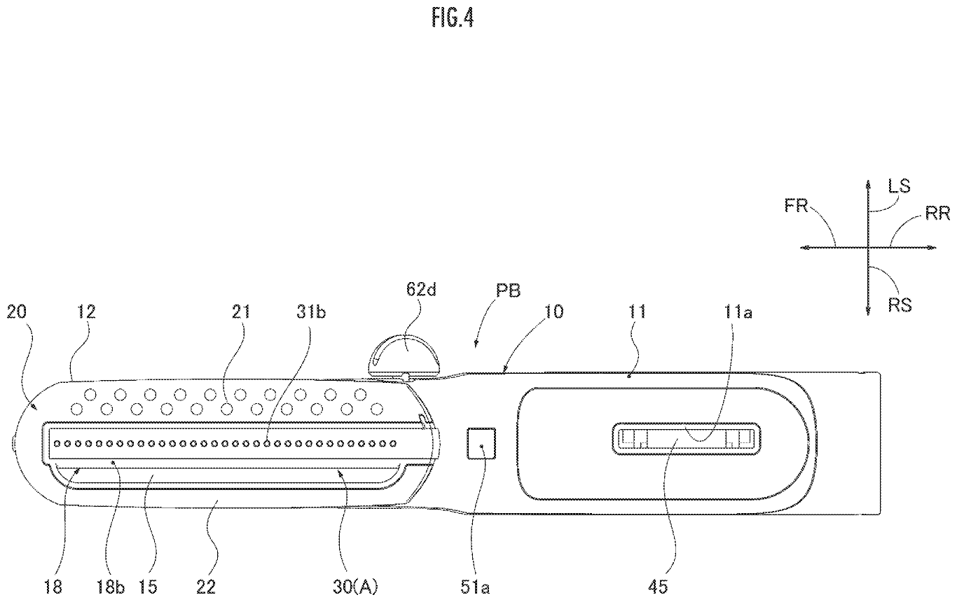

A portion of the lower surface of the suction portion 12 other than the suction port 15 and the brush support frame portion 18 is covered with the elastic cleaning portion 20. The elastic cleaning portion 20 is made of an elasticbody, such as silicon rubber, and is provided with an elastic projection portion 21 on the left side across the suction port 15 and an elastic flat portion 22, which is flat, on the right side, as illustrated in FIG. 4.

As illustrated in FIGS. 2 and 4, in the elastic projection portion 21, two rows on the left and right of columnar projections, which have a diameter of about 2 mm to 4 mm and a height of about 4 mm to 6 mm, are formed with different positions in the front-rear direction.

A dimension in the up-down direction of each projection of the elastic projection portion 21 is smaller than dimensions in the up-down direction of brush members 31, 312, and 313, which are brush portions of the replacement brush 30 and will be described below, protruding downward from the suction portion 12, and is set to a dimension that does not interfere with the use as the brush.

(Description of Replacement Brush)

The replacement brush 30 is attachable to and detachable from the head main body 10. Hereinafter, the structure thereof will be described in detail.

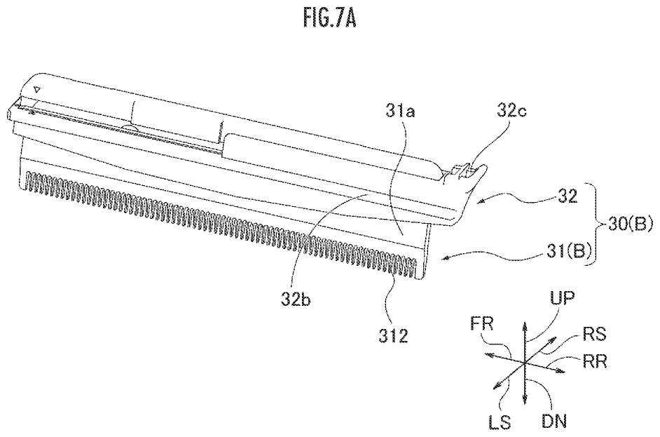

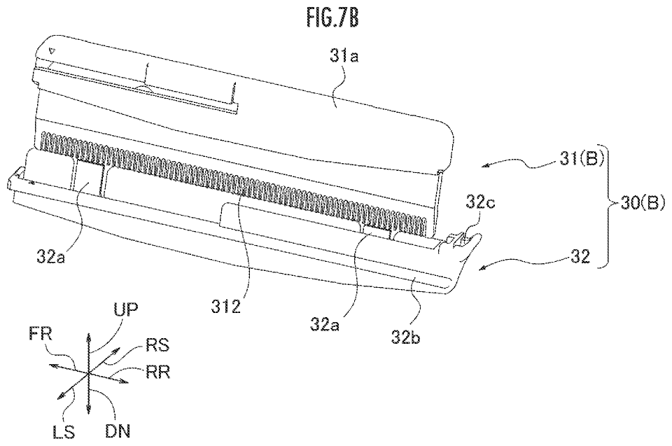

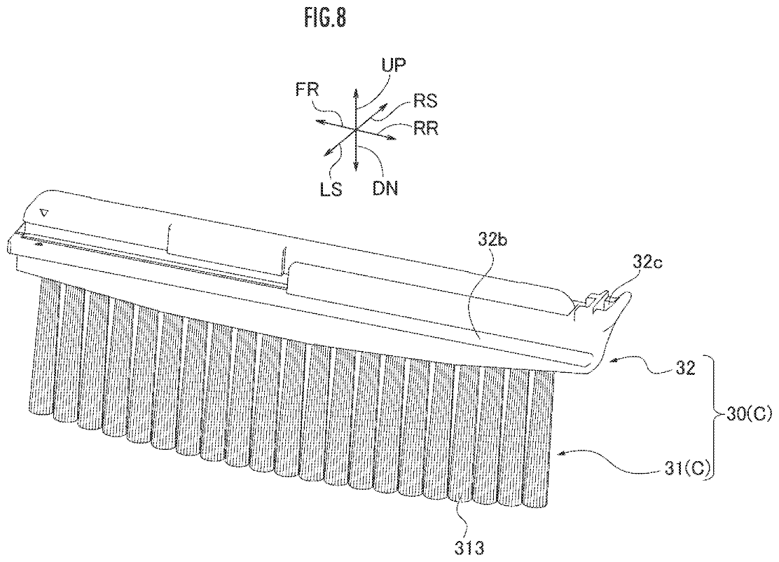

The replacement brush 30 includes the brush member 31 and the brush support member 32. In the replacement brush 30, depending on the shape of the brush member, which will be described below, a first replacement brush 30(A) of a pin type illustrated in FIGS. 1 to 6A and 6B, a second replacement brush 30(B) of a comb type illustrated in FIG. 7, and a third replacement brush 30(C) of a soft animal hair type illustrated in FIG. 8 are set.

Since the basic structures of these various brushes 30(A) to (C) are the same, hereinafter, the structure of the first replacement brush 30(A) of the pin type will be described as a representative example. In addition, in the description of each of the replacement brushes 30(A) to (C), in a case in which the replacement brushes 30(A) to (C) are generically referred to without distinction, the replacement brushes 30(A) to (C) are simply referred to as the replacement brush 30.

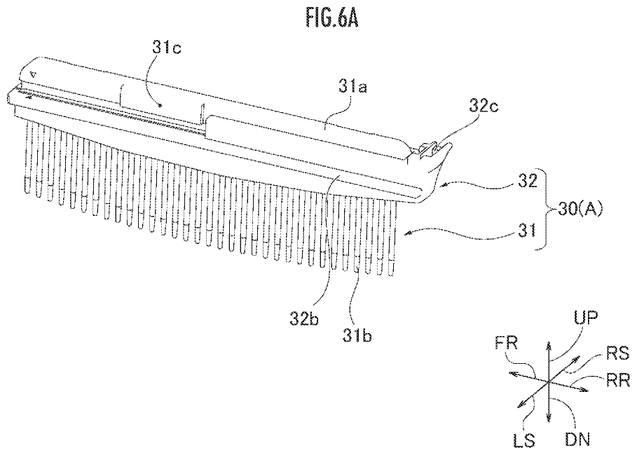

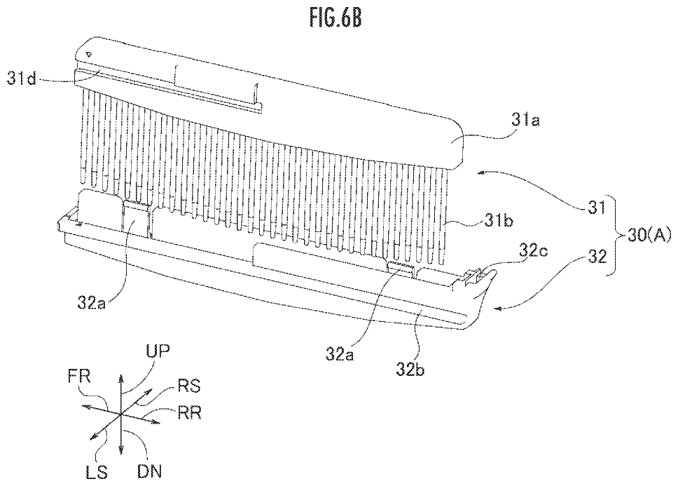

As illustrated in FIGS. 6A and 6B, the brush member 31 includes a base plate portion 31a that has a thin plate shape and is long in the front-rear direction, and a row of pin brushes 31b hung downward from the base plate portion 31a. The pin brush 31b is made of metal, such as stainless steel, a hard plastic, or the like. In addition, as illustrated in FIG. 6B, in the base plate portion 31a, an engagement slit 31d is formed from a front end portion rearward.

The brush support member 32 supports the brush member 31 to be movable up and down, is formed into an elongated frame shape, and includes a slit (not illustrated) that enables the pin brush 31b of the brush member 31 to be movable up and down and disables the base plate portion 31a to pass.

Further, as illustrated in FIG. 6B, the brush support member 32 includes a stopper piece 32a that is engaged with the base plate portion 31a at a use position at which the pin brush 31b protrudes downward from the brush support member 32 to suppress upward relative movement of the brush member 31.

In addition, the brush support member 32 includes a slide rail 32b to be attached to and detached from, and fixed to the head main body 10, and a lock groove 32c. The slide rail 32b protrudes into a protrusion shape from a left side portion of the brush support member 32 to the left direction, and extends in the front-rear direction over the entire length of the brush support member 32. By moving the slide rail 32b along an engagement slide groove 18c (see FIG. 5) provided in the brush support frame portion 18 of the head main body 10, it is possible to relatively slide the brush support member 32 in the front-rear direction while regulating the displacement of the brush support member 32 in the up-down direction with respect to the head main body 10.

In addition, the brush support member 32 is fixed (locked) by regulating the movement in the front-rear direction with respect to the suction portion 12 at a position at which the brush support member 32 is slid most forward from the attachment/detachment opening 18a with respect to the suction portion 12, that is, a position at which the use as the brush is enabled.

The regulation of the movement of the brush support member 32 in the front-rear direction is performed by the engagement between the lock groove 32c (support member lock) formed in the rear end portion of the brush support member 32 and the lock member 50 (support member lock) provided in the head main body 10.

As illustrated in FIGS. 3A, 6A and 6B, the lock groove 32c is formed into a V-shape downward at the rear end portion of the brush support member 32.

The lock member 50 includes a lock slider 51 and a spring 52.

The lock slider 51 is supported by the head main body 10 to be slidable up and down, and includes an unlocking button 51a and an engagement projection 51b at a lower portion thereof. The spring 52 is provided in a state of being wound around a pin 51c erected on the lock slider 51, and urges the lock slider 51 downward, that is, in a direction of being engaged with the lock groove 32c.

Therefore, in the extended state of the spring 52, as illustrated in FIG. 3B, the unlocking button 51a of the lock slider 51 protrudes downward from a lower surface of a front end portion of the grip portion 11 of the head main body 10, and the engagement projection 51b protrudes downward from a lower surface of a rear end portion of the head main body 10.

The engagement projection 51b in a state of protruding downward is capable of being engaged with the lock groove 32c of the brush support member 32 at the position at which the use as the brush is enabled, and in this engagement state, the replacement brush is in a lock state in which the sliding in the front-rear direction is regulated. In addition, in this lock state, the engagement slit 31d is also in the engagement state in the up-down direction, and the details thereof will be described below.

An inclination surface that is higher toward the rearward is formed on a front side of the lock groove 32c of the brush support member 32, and the inclination surface makes it possible to push up the engagement projection 51b in a case in which the brush support member 32 is slid forward.

In a case of unlocking the brush support member 32 in the front-rear direction, the unlocking button 51a is pushed upward as illustrated by an arrow F1 in FIG. 3B. As a result, the lock slider 51 is moved upward and the engagement between the engagement projection 51b and the lock groove 32c is released, and as illustrated in FIG. 3A, it is possible to slide the replacement brush 30 rearward to be detached from the head main body 10.

In the second replacement brush 30(B) illustrated in FIGS. 7A and 7B and the third replacement brush 30(C) illustrated in FIG. 8, the brush support member 32 that is common to the first replacement brush 30(A) is used, and the shapes of brush members 31(B) and 31(C) are different from the shape of the brush member 31.

That is, in the brush member 31(B) of the second replacement brush 30(B) illustrated in FIGS. 7A and 7B, the brush member 312 of the comb type made of metal or resin is hung from the base plate portion 31a. In addition, in the third replacement brush 30(C) illustrated in FIG. 8, the brush member 313 of the soft animal hair type is hung from the base plate portion 31a.

(Description of Up-Down Movement of Brush Member)

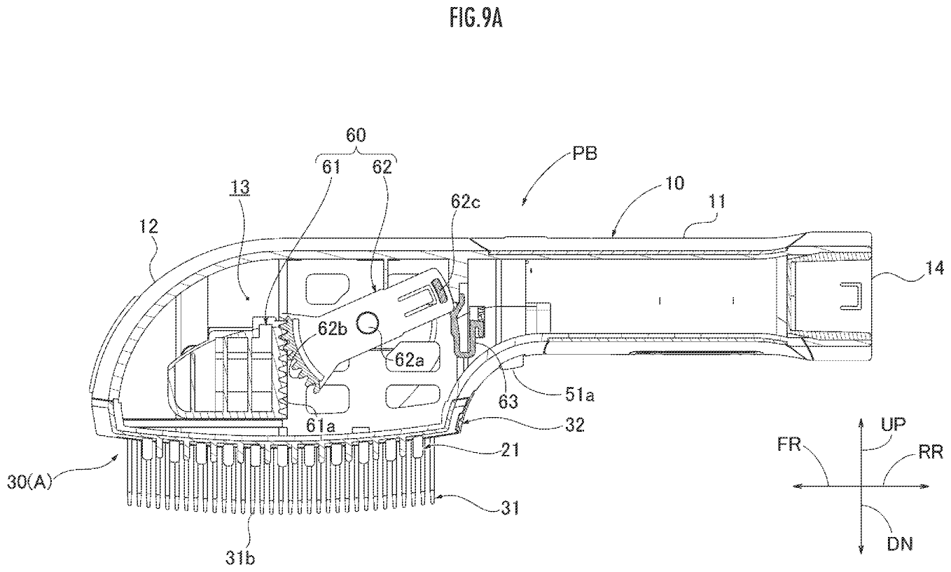

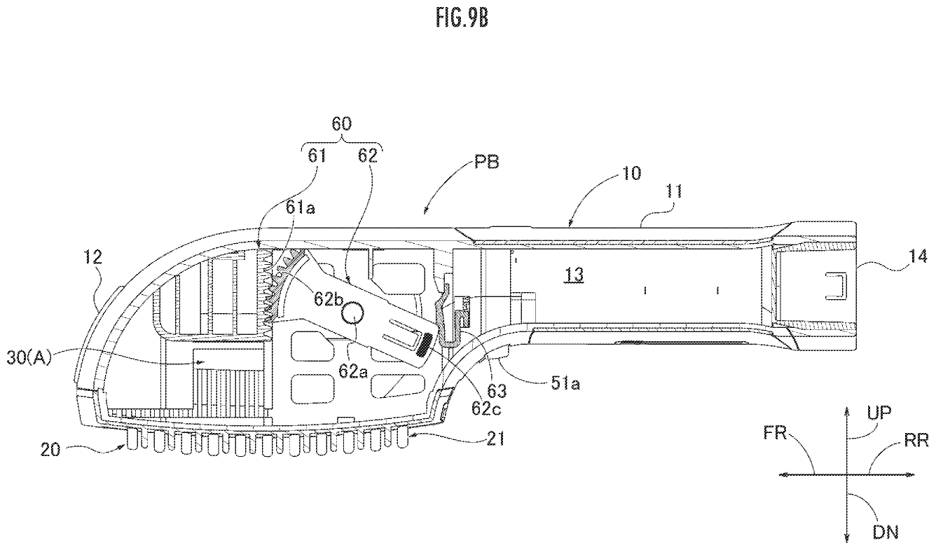

The head main body 10 includes an up-down slide mechanism 60 that moves the brush member 31 of the replacement brush 30 disposed at the position at which the use as the brush is enabled, up and down. That is, the brush member 31 is movable up and down, by the up-down slide mechanism 60, between the use position at which the brush member 31 protrudes from the lower surface of the head main body 10 as illustrated in FIG. 9A and the use as the brush is enabled, and the storage position at which the brush member 31 is stored in the hollow portion 13 of the suction portion 12 of the head main body 10 as illustrated in FIG. 9B.

The up-down slide mechanism 60 includes a rack slider 61 and a rotation gear 62.

The rack slider 61 is a plate material in which portions corresponding to an upper bottom and a front side leg of a trapezoidal shape are formed into a curved shape along an upper inner periphery of the head main body 10, and has a rack gear 61a formed along a rear end edge corresponding to a rear side leg of the trapezoidal shape. The rack slider 61 is supported by the intermediate wall 16 of the head main body 10 to be slidable up and down within a range between a lower position illustrated in FIG. 9A and an upper position illustrated in FIG. 9B.

Further, as illustrated in FIGS. 3A and 3B, in a lower end portion of the rack slider 61, a pair of upper and lower engagement pieces 61b and 61c that are engaged with the base plate portion 31a of the brush member 31 protrude to the lateral side. That is, when the rack slider 61 is disposed at the lower position illustrated in FIG. 9A, the lower engagement piece 61c is inserted into the engagement slit 31d of the base plate portion 31a of the brush member 31 and the upper engagement piece 61b is brought close to or in contact with an upper edge of the base plate portion 31a, as illustrated in FIGS. 3A and 3B. Therefore, both the engagement pieces 61b and 61c are relatively movable in the front-rear direction with respect to the base plate portion 31a, and are in the engagement state in the up-down direction.

As illustrated in FIGS. 9A and 9B, the rotation gear 62 is supported on the intermediate wall 16 of the head main body 10 to be rotatable up and down around a rotation shaft 62a. A pinion gear 62b that meshes with the rack gear 61a is formed at a front end portion of the rotation gear 62, and a brush operation lever 62c is provided at a rear end portion to protrude to the left side. In addition, the brush operation lever 62c protrudes outward from an arc-shaped slit 12a formed in the head main body 10 illustrated in FIGS. 1 and 2, and has an operation knob 62d provided at a distal end thereof.

Therefore, the rotation gear 62 is provided to be rotatable up and down around the rotation shaft 62a by operating the brush operation lever 62c. In a case in which the rotation gear 62 rotates up and down, the rack slider 61 slides up and down due to a relative change in the meshing position between the pinion gear 62b and the rack gear 61a, and the brush member 31 engaged with the rack slider 61 is moved up and down between the use position and the storage position.

In addition, a lock spring 63 is provided at a rearward position of the rotation gear 62 in the head main body 10. The lock spring 63 is brought in contact with a rear end portion of the rotation gear 62, and holds the rotation gear 62 at a position illustrated in FIG. 9A (position at which the brush member 31 is disposed at the use position) and a position illustrated in FIG. 9B (position at which the brush member 31 is disposed at the storage position) by predetermined elastic force.

(Description of Control Circuit)

Next, the control circuit 40 that controls suction and suction stop of the vacuum cleaner VC will be described.

As illustrated in FIG. 11, the control circuit 40 includes an operation switch 41 on an input side and an output circuit 42 on an output side.

As illustrated in FIGS. 3A and 3B, the operation switch 41 is provided in an upper portion of the front end portion of the grip portion 11 of the head main body 10, and an operation button 41a is provided to be exposed on the upper surface of the grip portion 11. That is, the operation button 41a is disposed at a position at which the user is able to easily operate the grip portion 11 in a state of holding the grip portion 11.

In response to the operation of the operation switch 41, the control circuit 40 outputs, from the output circuit 42, a signal for instructing the suction and a signal instructing the suction stop by a wireless signal WS, such as a radio wave or an infrared ray. The wireless signal WS is received by a reception circuit 71 of the vacuum cleaner VC, and the drive of a motor 73 that performs the suction operation of the vacuum cleaner VC is controlled by the control of the control circuit 72.

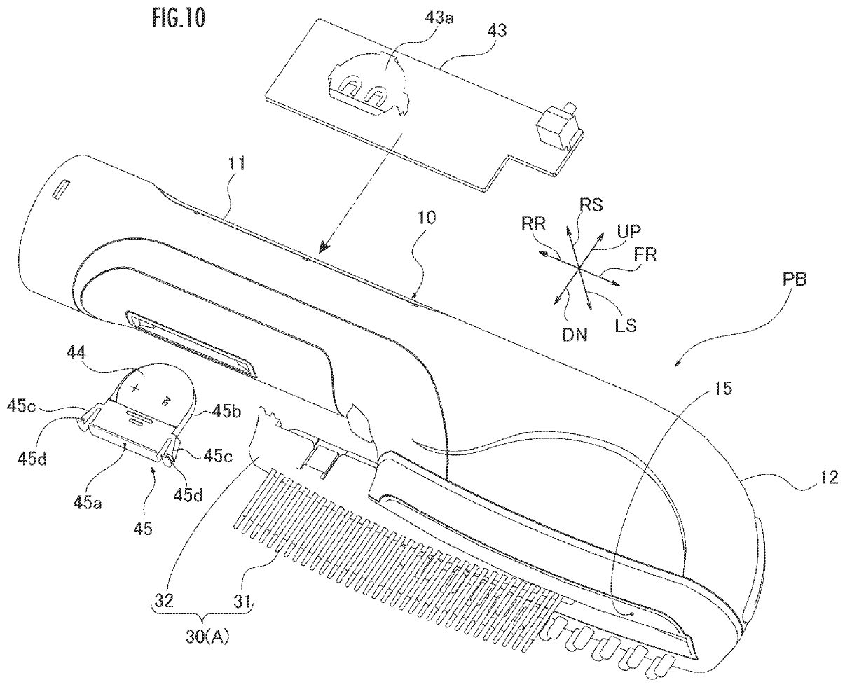

Here, in the first embodiment, the control circuit 40 is provided in a circuit board 43 mounted on the head main body 10 illustrated in FIG. 10, and includes a battery 44 which is a power source. The circuit board 43 is fixed to the intermediate wall 16 of the head main body 10, and the circuit board 43 is provided with a battery accommodation portion 43a for accommodating and connecting the battery 44.

As the battery 44, a so-called button battery is used, and the battery 44 is held in a battery holder 45 and is attachable to and detachable from the head main body 10. The battery holder 45 includes a base portion 45a and a ring portion 45b. The ring portion 45b is erected from the base portion 45a into a ring shape and is formed to be able to hold an outer periphery of the battery 44.

As illustrated in FIG. 2, the base portion 45a is formed to be attachable to and detachable from a battery attachment/detachment slit 11a that is open in a lower surface of the grip portion 11 of the head main body 10. Here, the base portion 45a is formed to have a width that allows the base portion 45a to be loosely fitted into the battery attachment/detachment slit 11a, and includes a pair of front and rear elastic arms 45c and 45c, as illustrated in FIGS. 3A and 3B. An engagement groove 45d is formed in the elastic arm 45c.

On the other hand, engagement pieces 11b and 11b that are engaged with the engagement groove 45d are provided in front and behind the battery attachment/detachment slit 11a of the head main body 10. These engagement pieces 11b and 11b are in the engagement state with the engagement grooves 45d and 45d of the elastic arms 45c and 45c when the battery holder 45 is inserted into the battery attachment/detachment slit 11a (see FIG. 3B), and the battery holder 45 and the battery 44 are fixed to the head main body 10. In this state, the battery 44 is disposed in the battery accommodation portion 43a of the circuit board 43 and is electrically connected to the control circuit 40. In addition, when the battery 44 is replaced, by performing elastic deformation to narrow an interval between the elastic arms 45c and 45c of the battery holder 45, it is possible to release the engagement between the engagement groove 45d and the engagement piece 11b, and to pull out the battery 44 from the battery attachment/detachment slit 11a together with the battery holder 45.

### Action of First Embodiment

Next, a method of using the pet brush PB according to the first embodiment will be described.

<Attachment and Detachment of Replacement Brush>

In a case in which the brushing is performed, the optimum replacement brush is selected from among the first to third replacement brushes 30(A), 30(B), and 30(C) depending on the length of the hair of the pet to be brushed and the application, and is attached to the head main body 10.

Here, in a case in which the first replacement brush 30(A) is attached to the head main body 10, as illustrated in FIG. 2, the brush support member 32 of the replacement brush 30(A) is inserted through the attachment/detachment opening 18a at the rear end of the suction portion 12 of the head main body 10 and is slid forward. In the brush support member 32, the slide rail 32b is moved forward while being guided by the engagement slide groove 18c inside the head main body 10, and pushes up the engagement projection 51b on the inclination surface on the front side of the lock groove 32c immediately before reaching the position at which the use as the brush is enabled. In a case in which the brush support member 32 is further slid forward, the engagement projection 51b is pushed down by the urging force of the spring 52 to be engaged with the lock groove 32c, and the lock state is established. In this case, the movement of the brush support member 32 in the left-right direction is also regulated by the side wall 18b of the brush support frame portion 18 of the head main body 10. In addition, the base plate portion 31a of the brush member 31 of the replacement brush 30(A) is in a state being engaged with the engagement pieces 61b and 61c of the rack slider 61 in the up-down direction to regulate the movement in the up-down direction. Therefore, the replacement brush 30(A) is fixed to the head main body 10, and the brushing by the replacement brush 30(A) is enabled.

<When Replacing Replacement Brush>

As the replacement brush 30, the first to third replacement brushes 30(A), 30(B), and 30(C) are set, and it is possible to use the first to third replacement brushes 30(A), 30(B), and 30(C) properly depending on the application.

For example, after removing fine dust or the like adhering to the surface of the hair of the pet by using the third replacement brush 30(C) of the animal hair type, the first replacement brush 30(A) of the pin type is used to clean the dog's hair coat or sebum. Thereafter, it is possible to finish the fur coat by using the second replacement brush 30(B) of the comb type. The method of using each of the replacement brushes 30(A), 30(B), and 30(C) is not limited to this, and for example, it is possible to select and use the optimum method depending on a difference in hair quality of the pets or a situation.

In a case in which such a plurality of types of the replacement brushes 30(A), 30(B), and 30(C) are used properly, first, the replacement brush 30 attached to the head main body 10 is detached. For example, as illustrated in FIG. 3B, in a case in which the first replacement brush 30(A) of the pin type is attached to the head main body 10, first, the unlocking button 51a is pushed upward (in the direction of the arrow F1 in the drawing) to release the lock state between the brush support member 32 and the lock slider 51. Then, the brush member 31 or the brush support member 32 is pulled rearward (in a direction of an arrow F2) as illustrated in FIG. 3A, so that it is possible to detach the replacement brush 30(A) from the head main body 10.

Next, in a case in which the second replacement brush 30(B) or the third replacement brush 30(C) is attached to the head main body, it is possible to perform the attachment by inserting the brush support member 32 forward through the attachment/detachment opening 18a at the rear end of the suction portion 12 of the head main body 10.

<When Performing Brushing>

In a case in which the brushing is performed, the suction hose SH connected to the vacuum cleaner VC is connected to the connection port 14 of the head main body 10 in advance. Then, the user holds the grip portion 11 of the head main body 10, and brushes the pet by using the brush member 31 protruding downward from the suction portion 12.

In addition, when performing the brushing, the suction operation of the vacuum cleaner VC is performed, and thus it is possible to suck the fallen hair caused by brushing, the sebum, or the dust adhering to the pet by the vacuum cleaner VC from the suction port through the suction hose SH and to suppress the scattering to the surroundings. In a case in which the suction operation of the vacuum cleaner VC is performed, it is possible to perform the suction operation of the vacuum cleaner VC by pushing the operation button 41a of the operation switch 41 provided in the grip portion 11. In addition, it is possible to stop the vacuum cleaner VC during the suction operation by pushing the operation button 41a again.

Here, in the first embodiment, since the suction hose (having a length of 3 m to 5 m) which is longer than the normal cleaning hose is used as the suction hose SH, the driving sound of the motor 73 of the vacuum cleaner VC is hard to reach the pet, and it is possible to suppress the irritation given by noise to the pet.

<When Cleaning Surroundings>

Next, a case in which the cleaning of a surrounding floor on which the brushing work is performed, the furniture, such as a sofa, the clothing of the user, or the like is performed, such as a case after brushing the pet, will be described.

In a case in which the cleaning is performed, it is possible to perform the cleaning while storing the brush member 31 in the head main body 10. In a case in which the brush member 31 is stored, the operation knob 62d and the brush operation lever 62c are pushed downward from the positions illustrated in FIGS. 1 and 2. By this operation, the rotation gear 62 rotates from the position illustrated in FIG. 9A to the position illustrated in FIG. 9B, and the rack slider 61 meshed with the pinion gear 62b of the rotation gear 62 is raised. Then, the brush member 31 that is engaged with the engagement pieces 61b and 61c of the rack slider 61 is raised and stored in the suction portion 12 of the head main body 10.

Therefore, as illustrated in FIG. 9B, on the lower surface of the suction portion 12, the elastic cleaning portion 20 is in the most protruding state, and it is possible to directly rub the surrounding floor on which the brushing work is performed by using the elastic cleaning portion 20, the furniture, such as the sofa, the clothing of the user, or the like. By rubbing an object to be cleaned using the elastic cleaning portion 20 made of the elastic body having a large friction coefficient, it is possible to scrape off the fallen hair, the sebum, and the dust adhering to the object to be cleaned.

At the same time, by performing the suction operation of the vacuum cleaner VC, it is possible to suck the fallen hair or the like scraped off by the elastic cleaning portion by the vacuum cleaner VC.

In this case, it is possible to remove the fallen hair or the sebum adhering to the pet, or the fallen hair, the sebum, or the like adhering to fiber, such as the sofa or the clothing, or a soft object by mainly using the elastic projection portion 21, and then to remove the sebum or the fine dust by using the elastic flat portion 22. In this way, it is possible to efficiently perform the cleaning by using the elastic projection portion 21 and the elastic flat portion 22 properly. Further, it is possible to remove the fallen hair or the sebum adhering to a flat and hard portion, such as the floor, by using the elastic flat portion 22.

As described above, in a case in which the cleaning is performed, it is possible to perform the absorption by the elastic cleaning portion 20 in addition to the suction by the vacuum cleaner VC, so that it is possible to more reliably remove the fallen hair, the sebum, or the like as compared with a case in which the suction is performed by using the cleaning head of the vacuum cleaner VC.

### Effect of First Embodiment

Hereinafter, the effects of the pet brush PB according to the first embodiment are listed.

(1) The pet brush PB according to the first embodiment includes the head main body 10 that is formed into a hollow shape and in which the connection port 14, which is connectable to the suction hose SH connected to the vacuum cleaner VC, and the suction port 15 for suction are open, the elastic cleaning portion 20 that is provided in the head main body 10 and is made of the elastic body, and the brush member 31 that is provided in the head main body 10. The brush member 31 is supported by the head main body 10 to be movable between the use position at which the brush member 31 protrudes from the head main body 10 and the storage position at which the brush member 31 is stored inside the head main body 10.

Therefore, when the brush member 31 is disposed at the use position, the use as the brush is enabled. In addition, when the brush member 31 is disposed at the storage position, it is possible to perform the cleaning by using the elastic cleaning portion 20 without the interference of the brush member 31. Moreover, even when the brush member 31 is used and when the cleaning is performed by using the elastic cleaning portion 20, it is possible to suppress the scattering of the fallen hair or the sebum by performing, as needed, the suction operation of the vacuum cleaner VC and performing the suction from the suction port 15.

As described above, two-way use is enabled only by moving the brush member 31 while the pet brush PB is connected to the suction hose SH, it is possible to more efficiently and easily perform the brushing, the cleaning of the fallen hair, or the like as compared with a case in which the jigs corresponding to the brush member 31 and the elastic cleaning portion 20 are replaced. In addition, in a case in which the cleaning using the elastic cleaning portion 20 is performed, it is possible to remove the fallen hair from the furniture or the like by using the frictional force, and it is possible to obtain higher removal performance as compared with a case in which the cleaning is performed by using only the suction force of the vacuum cleaner.

In addition, in the first embodiment, the elastic cleaning portion made of silicon rubber is used as the elastic cleaning portion 20, and it is possible to efficiently adsorb the fallen hair or the like.

(2) In the pet brush PB according to the first embodiment, at least one of the brush member 31 and the elastic cleaning portion 20 is provided to be attachable to and detachable from the head main body 10.

Therefore, since the brush member 31 is attachable and detachable, it is possible to use an optimum brush depending on the hair quality of the pet to be brushed or an application. In addition, since the elastic cleaning portion 20 is attachable and detachable, it is possible to use an optimum brush depending on the object to be cleaned.

(3) In the pet brush PB according to the first embodiment, as the brush member 31, a plurality of types of first to third brush members 31, 312, and 313 (replacement brushes 30(A), 30(B), and 30(C)) that are provided to be attachable to and detachable from the head main body 10 and have different brush shapes are set.

Therefore, as described in the (2), it is possible to selectively use the optimum brush members 31, 312, and 313 (replacement brushes 30(A), 30(B), and 30(C)) depending on the hair quality of the pet to be brushed or the application, and the usability is excellent.

(4) In the pet brush PB according to the first embodiment, the brush member 31 is provided to be attachable to and detachable from the head main body 10, and the brush member 31 is supported by the brush support member 32 to be movable between the use position and the storage position. The brush support member 32 is provided to be attachable to and detachable from the head main body 10 by sliding together with the brush member 31. The lock groove 32c, the lock slider 51, and the engagement projection 51b as the support member lock that regulates sliding of the brush support member 32 and fixes the brush support member 32 to the head main body 10 in a state in which the brush member 31 is disposed at the use position are provided.

Therefore, in a case in which the brush member 31 is attached to the head main body 10, the brush support member 32 need only be slid and attached to the head main body 10, and fixed by the support member lock. Therefore, the attachment/detachment operation is easier as compared with a case in which the replacement brush 30 is disposed at a predetermined position and fixed by a screw or the like.

In addition, in the first embodiment, in a case in which the brush support member 32 is slid, the lock state is established in which the engagement projection 51b and the lock groove 32c are automatically engaged with each other at the position at which the use as the brush is enabled. In addition, the brush member 31 is also engaged by the engagement pieces 61b and 61c, and the up-down movement is regulated. Therefore, it is only necessary to perform the operation of sliding the replacement brush 30, it is not necessary to manually perform the lock or the like, and the operability is excellent.

Further, for the unlocking, the replacement brush 30 is detachable only by pushing up the unlocking button 51a, and in this respect as well, the operability is excellent.

(5) In the pet brush PB according to the first embodiment, the elastic cleaning portion 20 includes the elastic projection portion 21 in which the plurality of elastic projections are erected, on one side across the brush member 31 and the suction port 15, and the elastic flat portion 22 having a substantially flat shape on the other side.

Therefore, by using the elastic projection portion 21 and the elastic flat portion 22 properly depending on the object to be cleaned (furniture, floor, or the like) or the removal object to be removed (fallen hair, sebum, or dust) while using one pet brush PB, it is possible to perform efficient cleaning. Since the elastic projection portion 21 and the elastic flat portion 22 are provided with the brush member 31 and the suction port 15 interposed therebetween, it is easy to selectively use one of the elastic projection portion 21 and the elastic flat portion 22, and the usability is excellent.

In addition, since the lower surface of the suction portion 12 forming the elastic cleaning portion 20 is formed into a gently curved surface shape that rises toward the forward, the rearward, the left, and the right with respect to the center, the contact with the object to be cleaned is easier, and the removal performance of the fallen hair or the like is more excellent as compared with a case in which the lower surface is formed flat.

(6) In the pet brush PB according to the first embodiment, the up-down slide mechanism 60 as the movement mechanism that moves the brush member 31 between the use position and the storage position is provided in the head main body 10.

Therefore, the brush member 31 is easy to move, and the operability is excellent. In particular, in the first embodiment, it is possible to move the brush member 31 between the use position and the storage position only by moving the operation knob 62d up and down, and the high operability is obtained.

(7) In the pet brush PB according to the first embodiment, the head main body 10 includes the control circuit 40 and the operation switch 41 as the remote control circuit capable of switching between a start and a stop of an suction operation of the vacuum cleaner VC.

Therefore, since it is possible to switch the suction operation of the vacuum cleaner VC by operating the operation switch 41 of the head main body 10, the operability is more excellent as compared with a case in which the switches of the vacuum cleaner VC are operated each time the suction is performed. In particular, in the first embodiment, since the operation switch 41 is provided on the upper surface of the grip portion 11 and it is possible for the user to perform the pressing operation with a thumb or an index finger in a state of holding the grip portion 11, the operability is excellent.

Further, in the first embodiment, since the suction hose having a length of 3 m to m is used as the suction hose SH, it is not necessary to operate the vacuum cleaner VC away from the pet brush PB each time the switching is performed, and the operability is excellent.

In addition, in the first embodiment, since the suction hose having a length of 3 m to 5 m is used as the suction hose SH, it is possible to separate the vacuum cleaner VC from the pet to be brushed, and it is possible to further suppress the irritation caused by noise given to the pet as compared with a case in which the suction hose SH is short. As a result, it is possible to suppress a situation in which the pet is in a psychologically uneasy state of and behaves wildly or dislikes being brushed in a case of the brushing.

The pet brush according to the present disclosure has been described above based on the embodiment. However, the specific configuration of the pet brush according to the present disclosure is not limited to these embodiments, and the combination, the change in design, the addition, and the like of the embodiments are permitted without departing from the gist of each claim within the scope of the claims.

Specifically, in the embodiment, the brush member is attachable to and detachable from the head main body, but the present disclosure is not limited to this, and the brush member may be fixed to the head main body.

In addition, in the embodiment, for the attachment and detachment of the brush member to and from the head main body, the brush support member is slid to the head main body to be attached and detached, but the present disclosure is not limited to this. For example, the base plate portion or the like of the brush member may be attachable to and detachable from the head main body. In this case, similarly to the brush support member, another attachment/detachment structure may be used, such as the attachment and detachment by sliding in the front-rear direction or the attachment and detachment by sliding in the up-down direction.

In addition, even in a case in which the brush support member is attached to and detached from the head main body, the brush support member is not limited to the configuration in which the sliding in the front-rear direction is performed along a slide guide as described in the embodiment. For example, a structure may be adopted in which the brush support member is brought in contact with the head main body at a predetermined position and is fixed to the head main body by a screw or a lock in that state. In addition, in this case, the engagement between the movement mechanism and the brush member is not limited to the engagement as described in the embodiment, and the engagement or connection using a screw, a pin, or the like may be adopted in addition to the engagement with each other.

In addition, the movement mechanism that moves the brush member between the use position and the storage position is not limited to the mechanism using the rotation as described in the embodiment, and for example, a member corresponding to the rack slider may be slid up and down.

In addition, in the embodiment, the brush support member is attached to the head main body separately from the suction port, but the present disclosure is not limited to this, and the brush support member may be attached to close a part of the suction port.

In addition, in the embodiment, the elastic cleaning portion is fixed to the head main body, but the present disclosure is not limited to this, and the elastic cleaning portion may be attachable to and detachable from the head main body. In this case, a plate-shaped elastic body forming the elastic cleaning portion may be fixed to the head main body by a surface fastener, a screw, or the like, or a member, which is slidable to the head main body and supports the elastic cleaning portion, may be attachable to and detachable from the head main body by sliding or the like, similarly to the replacement brush.

1. A pet brush comprising:
a main body that is formed into a hollow shape and in which a connection port, which is connectable to a hose connected to a vacuum cleaner, and a suction port for suction are open;
an elastic cleaning portion that is provided in the main body and is made of an elastic body; and
a brush member that is provided in the main body,
wherein the brush member is supported by the main body to be movable between a use position at which the brush member protrudes from the main body and a storage position at which the brush member is stored inside the main body.

2. The pet brush according to claim 1,
wherein at least one of the brush member and the elastic cleaning portion is provided to be attachable to and detachable from the main body.

3. The pet brush according to claim 2,
wherein, as the brush member, a plurality of types of brush members that are attachable to and detachable from the main body and have different brush shapes are set.

4. The pet brush according to claim 2,
wherein the brush member is supported by a brush support member to be movable between the use position and the storage position,
the brush support member is provided to be attachable to and detachable from the main body by sliding together with the brush member, and
a support member lock that regulates sliding of the brush support member and fixes the brush support member to the main body in a state in which the brush member is disposed at the use position is provided.

5. The pet brush according to claim 1,
wherein the elastic cleaning portion includes an elastic projection portion in which a plurality of elastic projections are erected, on one side across the brush member and the suction port, and an elastic flat portion having a substantially flat shape on the other side.

6. The pet brush according to claim 1,
wherein a movement mechanism that moves the brush member between the use position and the storage position is provided in the main body.

7. The pet brush according to claim 1,
wherein the main body includes a remote control circuit and an operation switch capable of switching between a start and a stop of a suction operation of the vacuum cleaner.
